(19) United States
(12) Patent Application Publication
(10) Pub. No.: US 2026/0317455 A1
(43) Pub. Date: Oct. 15, 2026

(54) CATALYST COMPONENTS FOR THE POLYMERIZATION OF OLEFINS

(71) Applicant: Basell Poliolefine Italia S.r.l., Milano (IT)

(72) Inventor: Alessandro Mignogna, Ferrara (IT)

(73) Assignee: Basell Poliolefine Italia S.r.l., Milano (IT)

(21) Appl. No.: 19/482,167

(22) PCT Filed: May 13, 2024
(86) PCT No.: PCT/EP2024/063028

§ 371 Date: Nov. 6, 2025

(30) Foreign Application Priority Data
May 15, 2023 (EP) 23173320.5

(51) Int. Cl. C08F 4/642; C08F 10/06

(52) U.S. Cl. CPC C08F 4/642; C08F 10/06; C08F 2410/04

(57) ABSTRACT

A catalyst component for the polymerization of olefins made from or containing Mg, Ti and an electron donor of formula (I):

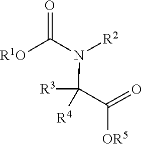

wherein the R¹ and R⁵ groups, equal to or different from each other, are selected from C₁-C₁₅ hydrocarbon groups, R² group is selected from C₃-C₁₀ alkyl groups or C₇-C₁₀ arylalkyl groups, R³ is hydrogen or C₁-C₂₀ hydrocarbon group and R⁴ is selected from a C₇-C₂₀ halogen substituted arylalkyl group.

### FIELD OF THE INVENTION

In general, the present disclosure relates to the field of chemistry. More specifically, the present disclosure relates to polymer chemistry. In particular, the present disclosure relates to catalyst components for the polymerization of olefins and to the catalysts obtained therefrom.

### BACKGROUND OF THE INVENTION

In some instances, catalyst components are used for the stereospecific polymerization of olefins. Concerning the polymerization of propylene, Ziegler-Natta catalysts are used which are made from or containing a solid catalyst component, constituted by a magnesium dihalide on which are supported a titanium compound and an internal electron donor compound, with an Al-alkyl compound. In some instances, an external donor is used to obtain higher crystallinity and isotacticity of the polymer. In some instances, the external donor is an alkoxysilane. In some instances, esters of phthalic acid are used as internal donors in catalyst preparations. In some instances, the ester of phthalic acid is diisobutylphthalate. In some instances, phthalates are used as internal donors in combination with alkylalkoxysilanes as external donor.

In some instances, applications seek polymers prepared with catalyst systems, in the absence of phthalates as an electron donor.

### SUMMARY OF THE INVENTION

In a general embodiment, the present disclosure provides a catalyst component for the polymerization of olefins made from or containing Mg, Ti and an electron donor of formula (I)

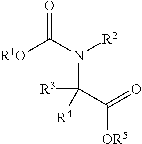

wherein the R¹ and R⁵ groups, equal to or different from each other, are selected from C₁-C₁₅ hydrocarbon groups, R² group is selected from C₃-C₁₀ alkyl groups or C₇-C₁₀ arylalkyl groups, R³ is hydrogen or C₁-C₂₀ hydrocarbon group and R⁴ is selected from a C₇-C₂₀ halogen substituted arylalkyl group.

### DETAILED DESCRIPTION OF THE INVENTION

In some embodiments, the “hydrocarbon group”, in reference to groups R¹ to R⁵, independently further contains a heteroatom selected from halogen, P, S, N, O and Si.

As used herein and if not separately specified, the term “alkyl group” also includes arylalkyl groups with the same carbon atom range, deriving from alkyl groups by replacement of a hydrogen atom with an aryl group.

In some embodiments, R¹ is a C₁-C₁₀ alkyl group or arylalkyl group, alternatively a C₁-C₈ alkyl group. In some embodiments, the alkyl group is a primary alkyl group.

In some embodiments, R² is selected from the group consisting of C₃-C₁₀ primary alkyl groups and primary C₇-C₁₀ arylalkyl groups.

In some embodiments, R³ is selected from the group consisting of hydrogen and C₁-C₁₅ alkyl groups. In some embodiments, R³ is hydrogen.

In some embodiments, R⁴ is selected from halogen substituted C₇-C₂₀ arylalkyl groups, alternatively from primary C₇-C₂₀ arylalkyl groups. In some embodiments, R⁴ is selected from halogen substituted C₇-C₁₅ arylalkyl groups. In some embodiments, the arylalkyl groups are selected from the group consisting of 4-chlorobenzyl, 3-chlorobenzyl, 2-chlorobenzyl, 3,4-dichlorobenzyl, 4-fluorobenzyl, 3-fluorobenzyl, 2-fluorobenzyl, 3,4-difluorobenzyl, 4-bromobenzyl, 3-bromobenzyl, 3,4-dibromobenzyl, 4-iodobenzyl, 2-iodobenzyl, 3-iodobenzyl, 3,4-iodobenzyl, 1-(4-chlorophenyl)ethyl, 1-(3-chlorophenyl)ethyl, 1-(3,4-dichlorophenyl)ethyl, 1-(4-chlorophenyl) propyl, 1-(3-chlorophenyl) propyl, 1-(3,4-dichlorophenyl) propyl, 1-(4-chlorophenyl)butyl, 1-(3-chlorophenyl)butyl, 1-(3,4-dichlorophenyl)butyl, (4-chloronaphthalen-1-yl)methyl, and (6-chloronaphthalen-1-yl)methyl, (1-(3,4-difluorophenyl)-2-methylpropyl. In some embodiments, R⁴ is selected from halo substituted benzyl structures.

In some embodiments, the halogen substituent is positioned on the aromatic ring of the arylalkyl group. In some embodiments, the aromatic rings are substituted with one or more halogen atoms.

In some embodiments, each isolated or condensed aromatic ring is substituted with halogens. In some embodiments, the number of halogens ranges from 1 to 2.

In some embodiments and with reference to a phenyl ring, various positions are substituted. In some embodiments, the positions are meta, para, or both. In some embodiments, the positions are para.

In some embodiments, the halogens are selected from the group consisting of Br, C₁ and F. In some embodiments, the halogens are C₁.

In some embodiments and in addition to the halogen substitution, the aromatic moiety of the arylalkyl groups is substituted with C₁-C₁₀ alkyl group, alternatively a C₁-C₈ alkyl group.

In some embodiments, R⁵ is a C₁-C₁₀ alkyl group, alternatively a C₁-C₈ alkyl group. In some embodiments, the alkyl group is a primary alkyl group.

In some embodiments, R¹ and R⁵ are independently a C₁-C₁₀ alkyl group, R² is selected from C₂-C₁₀ alkyl or C₇-C₁₀ arylalkyl groups, R³ is hydrogen and R⁴ is a halogen substituted benzyl group.

In some embodiments, the final amount of electron donor compound in the solid catalyst component ranges from 1 to 25% by weight, alternatively from 3 to 20% by weight.

In some embodiments, the compounds of formula (I) are selected from the group consisting of:
ethyl 3-(4-chlorophenyl)-2-((ethoxycarbonyl)(methyl)amino)propanoate, ethyl 3-(4-chlorophenyl)-2-((ethoxycarbonyl)(propyl)amino)propanoate, ethyl 3-(4-chlorophenyl)-2-((ethoxycarbonyl)(ethyl)amino)propanoate, ethyl 3-(3,4-dichlorophenyl)-2-((ethoxycarbonyl)(isopentyl)amino)propanoate, ethyl 3-(3-chlorophenyl)-2-((ethoxycarbonyl)(propyl)amino)propanoate, ethyl 3-(2-chlorophenyl)-2-((ethoxycarbonyl)(propyl)amino)propanoate, ethyl 3-(4-chlorophenyl)-2-((ethoxycarbonyl)(isobutyl)amino)propanoate, ethyl 3-(4-chlorophenyl)-2-((ethoxycarbonyl)(isopentyl)amino)propanoate, ethyl 3-(4-chlorophenyl)-2-((ethoxycarbonyl)(hexyl)amino)propanoate, ethyl 3-(3,4-dichlorophenyl)-2-((ethoxycarbonyl)(isobutyl)amino)propanoate, ethyl 3-(3,4-dichlorophenyl)-2((ethoxycarbonyl)(hexyl)amino)propanoate, ethyl 2-((ethoxycarbonyl)(hexyl)amino)-3-(4-fluorophenyl)propanoate, ethyl 3-(3,4-difluorophenyl)-2-((ethoxycarbonyl)(isopentyl)amino)propanoate, ethyl 3-(3,4-difluorophenyl)-2-((ethoxycarbonyl)(isobutyl)amino)propanoate, ethyl 3-(3,4-difluorophenyl)-2-((ethoxycarbonyl)(hexyl)amino)propanoate, ethyl 3-(3-bromophenyl)-2-((ethoxycarbonyl)(isopentyl)amino)propanoate, ethyl 3-(3-bromophenyl)-2-((ethoxycarbonyl)(hexyl)amino)propanoate, ethyl 3-(4-bromophenyl)-2-((ethoxycarbonyl)(hexyl)amino)propanoate, ethyl 2-((ethoxycarbonyl)(hexyl)amino)-3-(3-fluorophenyl)propanoate, ethyl 2-((ethoxycarbonyl)(isobutyl)amino)-3-(4-fluorophenyl)propanoate, ethyl 2-((ethoxycarbonyl)(isopentyl)amino)-3-(4-fluorophenyl)propanoate, ethyl 2-((ethoxycarbonyl)(isopentyl)amino)-3-(3-fluorophenyl)propanoate, ethyl 2-((ethoxycarbonyl)(isobutyl)amino)-3-(3-fluorophenyl)propanoate, ethyl 2-((ethoxycarbonyl)(isobutyl)amino)-3-(4-iodophenyl)propanoate, ethyl 3-(3-bromophenyl)-2-((ethoxycarbonyl)(isobutyl)amino)propanoate, ethyl 3-(4-bromophenyl)-2-((ethoxycarbonyl)(isobutyl)amino)propanoate, ethyl 3-(4-bromophenyl)-2-((ethoxycarbonyl)(isopentyl)amino)propanoate, ethyl 2-((ethoxycarbonyl)(hexyl)amino)-3-(4-iodophenyl)propanoate, ethyl 2-((ethoxycarbonyl)(isopentyl)amino)-3-(4-iodophenyl)propanoate, ethyl 3-(4-chlorophenyl)-2-(ethyl(isobutoxycarbonyl)amino)propanoate, ethyl 3-(4-chlorophenyl)-2-((ethoxycarbonyl)(propyl)amino)propanoate, ethyl 3-(3-chlorophenyl)-2-((ethoxycarbonyl)(propyl)amino)propanoate, ethyl 3-(2-chlorophenyl)-2-((ethoxycarbonyl)(propyl)amino)propanoate, ethyl 3-(4-chlorophenyl)-2-((ethoxycarbonyl)(isobutyl)amino)propanoate, ethyl 3-(4-chlorophenyl)-2-((ethoxycarbonyl)(isopentyl)amino)propanoate, ethyl 3-(4-chlorophenyl)-2-((ethoxycarbonyl)(hexyl)amino)propanoate, butyl 2-((butoxycarbonyl)(isobutyl)amino)-3-(4-chlorophenyl)propanoate, isobutyl 3-(4-chlorophenyl)-2-((ethoxycarbonyl)(methyl)amino)propanoate, ethyl 2-((butoxycarbonyl)(propyl)amino)-3-(4-chlorophenyl)propanoate, isobutyl 3-(4-chlorophenyl)-2-(ethyl(isobutoxycarbonyl)amino)propanoate, butyl 3-(3-chlorophenyl)-2-((ethoxycarbonyl)(propyl)amino)propanoate, ethyl 3-(4-chlorophenyl)-2-((ethoxycarbonyl)(hexyl)amino)-4-methylpentanoate, ethyl 3-(4-chlorophenyl)-2-((ethoxycarbonyl)(isopentyl)amino)pentanoate, ethyl 3-(4-chlorophenyl)-2-((ethoxycarbonyl)(isobutyl)amino)butanoate, ethyl 3-(4-chlorophenyl)-2-((ethoxycarbonyl)(isobutyl)amino)butanoate, ethyl 3,3-bis(4-chlorophenyl)-2-((ethoxycarbonyl)(isopentyl)amino)propanoate, ethyl 3-(4-chlorophenyl)-2-((ethoxycarbonyl)(hexyl)amino)-4-methylpentanoate, ethyl 3-(3-chlorophenyl)-2-((ethoxycarbonyl)(propyl)amino)-2-methylpropanoate, ethyl 2-(4-chlorobenzyl)-2-((ethoxycarbonyl)(isopentyl)amino)butanoate, and ethyl 2-(4-chlorobenzyl)-2-((ethoxycarbonyl)(hexyl)amino)-3-methylbutanoate.

In some embodiments, the compounds of formula (I) are prepared by using the following synthetic route:

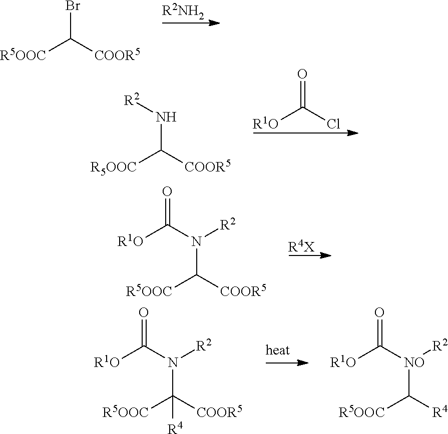

In some embodiments and in the solid catalyst component, the amount of Ti atoms is higher than 2% wt, alternatively higher than 2.5% with respect to the total weight of the catalyst component.

In some embodiments, the catalyst components are made from or containing the electron donors, Ti, Mg and halogen. In some embodiments, the catalyst components are made from titanium compound, having at least a Ti-halogen bond, and the electron donor compounds, supported on a Mg halide. In some embodiments, the magnesium halide is MgCl₂, in active form. In some embodiments, the use of magnesium halides in Ziegler-Natta catalysis is as described in U.S. Pat. Nos. 4,298,718 and 4,495,338. For some embodiments, U.S. Pat. Nos. 4,298,718 and 4,495,338 describe the use of magnesium dihalides in active form as support or co-support in components of catalysts for the polymerization of olefins. In some embodiments, the magnesium dihalides, in active form, have X-ray spectra, wherein the most intense diffraction line in the spectrum of the non-active halide is diminished in intensity and replaced by a halo having maximum intensity displaced towards lower angles relative to that of the more intense line.

In some embodiments, titanium compounds are selected from the group consisting of TiCl₄ and TiCl₃. In some embodiments, titanium compounds are Ti-haloalcoholates of formula Ti(OR⁶)_{m-y}X_{y}, wherein m is the valence of titanium, y is a number between 1 and m-1, X is halogen and R⁶ is a hydrocarbon radical having from 1 to 10 carbon atoms.

In some embodiments, the solid catalyst component is prepared by a reaction between magnesium alcoholates or chloroalcoholates and an excess of TiCl₄ in the presence of the electron donor compounds at a temperature of about 80 to 120° C. In some embodiments, the chloroalcoholates are prepared according to U.S. Pat. No. 4,220,554.

In some embodiments, the solid catalyst component is prepared by reacting a titanium compound of formula Ti(OR⁷)_{m-y}X_{y}, wherein m is the valence of titanium and y is a number between 1 and m, with a magnesium chloride deriving from an adduct of formula MgCl₂·pR⁸OH, wherein p is a number between 0.1 and 6, alternatively from 2 to 3.5, and R⁸ is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as described in U.S. Pat. Nos. 4,399,054 and 4,469,648. In some embodiments, the adduct is directly reacted with Ti compound or subjected to thermal controlled dealcoholation (80-130° C.), thereby obtaining an adduct in which the number of moles of alcohol is lower than 3, alternatively between 0.1 and 2.5. In some embodiments, the reaction with the Ti compound is carried out by suspending the adduct (dealcoholated or as such) in cold TiCl₄ (about 0° C.). In some embodiments, the mixture is heated up to 80-130° C. and kept at this temperature for 0.5-2 hours. In some embodiments, the treatment with TiCl₄ is carried out one or more times. In some embodiments, the electron donor compound is added during the treatment with TiCl₄. In some embodiments, the preparation of catalyst components in spherical form occurs as described in European Patent Application Nos. EP-A-395083, EP-A-553805, EP-A-553806, and EPA601525 and Patent Cooperation Treaty Publication No. WO98/44009.

In some embodiments, the solid catalyst components show a surface area (by B.E.T. method) between 20 and 500 m²/g, alternatively between 50 and 400 m²/g, and a total porosity (by B.E.T. method) higher than 0.2 cm³/g, alternatively between 0.2 and 0.6 cm³/g. In some embodiments, the porosity (Hg method) due to pores with radius up to 10.000 Å ranges from 0.3 to 1.5 cm³/g, alternatively from 0.45 to 1 cm³/g.

In some embodiments, the solid catalyst component has an average particle size ranging from 5 to 120 μm, alternatively from 10 to 100 μm.

In some embodiments, the electron donor compounds are added as such or obtained in situ by using a precursor.

In some embodiments, the final amount of the electron donor compound provides a molar ratio with respect to the Ti atoms ranging from 0.01:1 to 2:1, alternatively from 0.05:1 to 1.5:1. In some embodiments, the solid catalyst components are converted into catalysts for the polymerization of olefins by reacting the solid catalyst components with organoaluminum compounds.

In some embodiments, the present disclosure provides a catalyst or catalyst system for the polymerization of olefins CH₂═CHR, wherein R is hydrogen or a hydrocarbyl radical with 1-12 carbon atoms, made from or containing the product obtained by contacting:
(i) the solid catalyst component and
(ii) an alkylaluminum compound and optionally,
(iii) an external electron donor compound.

In some embodiments, the alkyl-Al compound (ii) is a trialkyl aluminum compound. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the alkyl-Al compound (ii) is selected from the group consisting of alkylaluminum halides, alkylaluminum hydrides, alkylaluminum sesquichlorides, and mixtures with trialkylaluminum compounds. In some embodiments, the alkylaluminum sesquichlorides are AlEt₂Cl or Al₂Et₃Cl₃.

In some embodiments, the external electron-donor compounds are selected from the group consisting of silicon compounds, ethers, esters, amines, and heterocyclic compounds.

In some embodiments, the external donor compounds (iii) are silicon compounds of formula (R⁹)ₐ(R¹⁰)_{b}Si(OR¹¹)_{c}, where a and b are integers from 0 to 2, c is an integer from 1 to 4 and the sum (a+b+c) is 4; R⁹, R¹⁰, and R¹¹, are radicals with 1-18 carbon atoms optionally containing heteroatoms. In some embodiments, the external donor compounds (iii) are silicon compounds wherein a is 1, b is 1, c is 2, at least one of R⁷ and R⁸ is selected from branched alkyl, cycloalkyl or aryl groups with 3-10 carbon atoms optionally containing heteroatoms and R⁹ is a C₁-C₁₀ alkyl group. In some embodiments, R⁹ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl) t-butyldimethoxysilane, (2-ethylpiperidinyl) thexyldimethoxysilane, (3,3,3-trifluoro-n-propyl) (2-ethylpiperidinyl)dimethoxysilane, methyl (3,3,3-trifluoro-n-propyl)dimethoxysilane, and N,N-diethylaminotriethoxysilane. In some embodiments, the external donor compounds are the silicon compounds wherein a is 0, c is 3, R⁸ is a branched alkyl or cycloalkyl group, optionally containing heteroatoms, and R⁹ is methyl. In some embodiments, the silicon compounds are selected from the group consisting of cyclohexyltrimethoxysilane, t-butyltrimethoxysilane and thexyltrimethoxysilane.

In some embodiments, the amount of electron donor compound (iii) provides a molar ratio between the organoaluminum compound and the electron donor compound (iii) of from 0.1 to 500, alternatively from 1 to 300, alternatively from 3 to 100.

In some embodiments, the catalyst components are used to produce polypropylene, with a polymerization activity higher than 35 kgₚₒₗ/g_{cat}, alternatively higher than 40 kgₚₒₗ/g_{cat}, and a xylene insolubility at 25° C. higher than 96% wt, alternatively higher than 97% wt. In some embodiments, the catalyst components are used with an aluminum alkyl compound and an alkyl alkoxysilane.

In some embodiments, the present disclosure provides a process for the homopolymerization or copolymerization of olefins CH₂═CHR, wherein R is hydrogen or a hydrocarbyl radical with 1-12 carbon atoms, carried out in the presence of a catalyst made from or containing the product of the reaction between:
(i) the solid catalyst component;
(ii) an alkylaluminum compound, and
(iii) optionally an electron-donor compound (external donor).

In some embodiments, the polymerization process is carried out in a slurry polymerization using as diluent an inert hydrocarbon solvent, or in bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, the polymerization is carried out at temperature of from 20 to 120° C., alternatively of from 40 to 80° C. In some embodiments, the polymerization is carried out in gas-phase with an operating pressure between 0.5 and 5 MPa, alternatively between 1 and 4 MPa. In some embodiments, the polymerization is carried out in a bulk polymerization with the operating pressure between 1 and 8 MPa, alternatively between 1.5 and 5 MPa.

The following examples are given to illustrate the disclosure without being intended as limiting the disclosure.

### Characterizations

### Determination of X.I.

2.5 g of polymer and 250 ml of o-xylene were placed in a round-bottomed flask, provided with a cooler and a reflux condenser, and kept under nitrogen. The resulting mixture was heated to 135° C. and kept under stirring for about 60 minutes. The final solution was cooled to 25° C. under continuous stirring. The insoluble polymer was then filtered. The filtrate was evaporated in a nitrogen flow at 140° C. to reach a constant weight. The content of xylene-soluble fraction was expressed as a percentage of the original 2.5 grams and then, by difference, the X.I. %.

### Determination of Donors.

The content of electron donor was carried out via gas-chromatography. The solid component was dissolved in acidic water. The solution was extracted with ethyl acetate. An internal standard was added. A sample of the organic phase was analyzed in a gas chromatograph, thereby determining the amount of donor present at the starting catalyst compound.

### Melt Flow Rate (MFR)

The melt flow rate MIL of the polymer was determined according to ISO 1133 (230° C., 2.16 Kg).

### EXAMPLES

### Procedure for Preparation of the Spherical Adduct

An initial amount of microspheroidal MgCl₂·2.8C₂H₅OH was prepared according to the method described in Example 2 of Patent Cooperation Treaty Publication No. WO98/44009, but operating on a larger scale.

### General Procedure for the Polymerization of Propylene

A 4-liter steel autoclave, equipped with a stirrer, pressure gauge, thermometer, catalyst feeding system, monomer feeding lines and thermostatic jacket, was purged with nitrogen flow at 70° C. for one hour. Then, at 30° C. under propylene flow, the autoclave was charged, in sequence, with 75 mL of anhydrous hexane, 0.76 g of AlEt₃, dicyclopentyl dimethoxysilane as external electron donor, thereby providing an Al/Donor molar ratio of 20, and 0.006-0.010 g of solid catalyst component. The autoclave was closed; subsequently 2.0 NL of hydrogen were added. Then, under stirring, 1.2 kg of liquid propylene was fed. The temperature was raised to 70° C. in five minutes. The polymerization was carried out at this temperature for two hours. At the end of the polymerization, the non-reacted propylene was removed. The polymer was recovered and dried at 70° C. under vacuum for three hours. Then, the polymer was weighed and fractionated with o-xylene to determine the amount of the xylene insoluble (X.I.) fraction.

### Procedure for the Preparation of the Solid Catalyst Component

Into a 500 cm³ round bottom flask, equipped with mechanical stirrer, cooler and thermometer, 250 cm³ of TiCl₄ were introduced at room temperature under nitrogen atmosphere. After cooling to 0° C., while stirring, the internal donor of listed in Table 1 and 10.0 g of the spherical adduct were sequentially added into the flask. The amount of charged internal donor provided a Mg/donor molar ratio of 6. The temperature was raised to 100° C. and maintained for 2 hours. Thereafter, stirring was stopped. The solid product settled. The supernatant liquid was siphoned off at 100° C. After the supernatant was removed, additional fresh TiCl₄ was added to reach the initial liquid volume again. The mixture was then heated at 120° C. and kept at this temperature for 1 hour. Stirring was stopped again. The solid was settled. The supernatant liquid was siphoned off. The solid was washed with anhydrous hexane six times (6×100 cm³) in temperature gradient down to 60° C. and one time (100 cm³) at room temperature. The solid was then dried under vacuum. The solid catalyst components were tested in polymerization of propylene. The results are listed in Table 1.

### Example 1-6 and Comparative Examples 1-2

### Preparation of Solid Catalyst Component and Polymerization

The procedure for the preparation of the solid catalyst component 1 was carried out using the donor reported in Table 1 as internal donor. The solid catalyst components were tested in polymerization of propylene. The results are listed in Table 1.

TABLE 1

| | Catalyst composition | | | Polymerization | | |
|---|---|---|---|---|---|---|
| | Internal Donor | | Ti | Activity | XI | MIL |
| EX | Structure | % wt | % wt | kg/g | % wt | g/10′ |
| 1 | 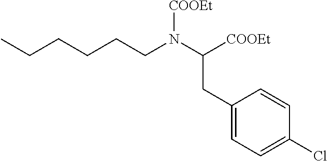 [SMILES: CCCCCCN(C(=O)OCC)C(Cc1ccc(Cl)cc1)C(=O)OCC] | 18.5 | 3.7 | 108 | 97.3 | 3.7 |
| 2 | 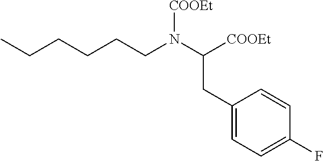 [SMILES: CCCCCCN(C(=O)OCC)C(Cc1ccc(F)cc1)C(=O)OCC] | 15.6 | 3.7 | 89 | 97.4 | 3.4 |
| 3 | 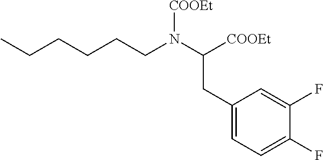 [SMILES: CCCCCCN(C(=O)OCC)C(Cc1ccc(F)c(F)c1)C(=O)OCC] | 16.7 | 3.1 | 83 | 98.0 | 4.6 |
| 4 | 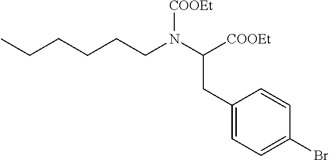 [SMILES: CCCCCCN(C(=O)OCC)C(Cc1ccc(Br)cc1)C(=O)OCC] | 18.4 | 3.6 | 85 | 97.6 | 2.8 |
| 5 | 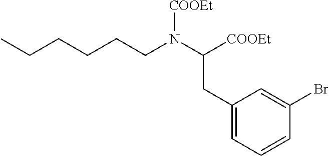 [SMILES: CCCCCCN(C(=O)OCC)C(Cc1cccc(Br)c1)C(=O)OCC] | 18.5 | 3.8 | 84 | 97.3 | 4.0 |
| 6 | 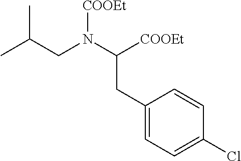 [SMILES: CCOC(=O)C(Cc1ccc(Cl)cc1)N(CC(C)C)C(=O)OCC] | 17.4 | 4.1 | 92 | 97.6 | 3.1 |
| C1 | 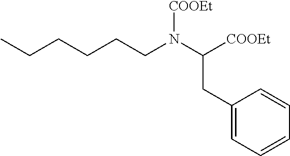 [SMILES: CCCCCCN(C(=O)OCC)C(Cc1ccccc1)C(=O)OCC] | 14.0 | 3.7 | 86 | 97.0 | 3.6 |
| C2 | 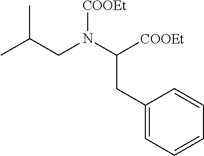 [SMILES: CCOC(=O)C(Cc1ccccc1)N(CC(C)C)C(=O)OCC] | 13.3 | 3.8 | 71 | 97.3 | 2.8 |

What is claimed is:

1. A catalyst component for the polymerization of olefins comprising Mg, Ti and an electron donor of formula (I): 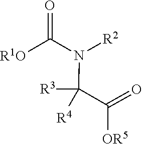
wherein the R¹ and R⁵ groups, equal to or different from each other, are selected from C₁-C₁₅ hydrocarbon groups, R² group is selected from C₃-C₁₀ alkyl groups or C₇-C₁₀ arylalkyl groups, R³ is hydrogen or C₁-C₂₀ hydrocarbon group and R⁴ is selected from a C₇-C₂₀ halogen substituted arylalkyl group.

2. The catalyst component according to claim 1, wherein R¹ is a C₁-C₁₀ alkyl group or arylalkyl group.

3. The catalyst component according to claim 3, wherein R² is selected from the group consisting of C₃-C₁₀ primary alkyl groups and primary C₇-C₁₀ arylalkyl groups.

4. The catalyst component according to claim 1, wherein R³ is selected from the group consisting of hydrogen er a and C₁-C₁₅ alkyl groups.

5. The catalyst component according to claim 5, wherein R³ is hydrogen.

6. The catalyst component according to claim 1, wherein R⁴ is selected from halogen substituted primary C₇-C₂₀ arylalkyl groups.

7. The catalyst component according to claim 1, wherein R⁴ is selected from halogen substituted C₇-C₁₅ arylalkyl groups.

8. The catalyst component according to claim 1, wherein, in R⁴, the halogen substituent is positioned on the aromatic ring of the arylalkyl group, and the aromatic rings are substituted with one or more halogen atoms.

9. The catalyst component according to claim 9, wherein, with reference to a phenyl ring, the halogen substitution is in meta, para, or both.

10. The catalyst component according to claim 1, wherein, in R⁴, the halogen is selected from the group consisting of Br, C₁ and F.

11. The catalyst component according to claim 1, wherein, in addition to the halogen substitution, the aromatic moiety of the arylalkyl groups is substituted with a C₁-C₁₀ alkyl group.

12. The catalyst component according to claim 1, wherein R⁵ is a C₁-C₁₀ alkyl group.

13. A catalyst for the polymerization of olefins comprising the product of the reaction between:
(i) the solid catalyst component according to claim 1 and
(ii) an alkylaluminum compound.

14. The catalyst according to claim 13, further comprising an external electron donor compound.

15. A process for the homopolymerization or copolymerization of olefins CH₂═CHR, wherein R is hydrogen or a hydrocarbyl radical with 1-12 carbon atoms, carried out in the presence of a catalyst comprising the product of the reaction between:
i. the solid catalyst component according to claim 1; and
ii. an alkylaluminum compound.
